(19) United States
(12) Patent Application Publication
(10) Pub. No.: US 2026/0293867 A1
(43) Pub. Date: Oct. 1, 2026

(54) BOTTOM RIG

(71) Applicant: Shasta Marie Renner, Jacksonville, NC (US)

(72) Inventor: Shasta Marie Renner, Jacksonville, NC (US)

(21) Appl. No.: 19/096,898

(22) Filed: Apr. 1, 2025

(51) Int. Cl. A01K 85/00

(52) U.S. Cl. CPC A01K 85/1837

(57) ABSTRACT

Disclosed is a bottom rig including: (a) a metal tube; (b) a casting material within the metal tube; (c) a wire loop running through and extending beyond the casting material and the metal tube; (d) a top slide ring removably attached to a top of the wire loop; and (e) a bottom slide ring removably attached to a bottom of the wire loop. The top slide ring is removably attachable to a swivel on a fishing rod. A hook can be removably attached to the bottom slide ring. A process for making the bottom rig is also disclosed.

### TECHNICAL FIELD

This invention relates to fishing equipment. Specifically, this invention relates for a bottom rig and a process for making the bottom rig.

### BACKGROUND

Having a bottom rig that is easy to use and brings in the fish is the dream of every fisherman. Bottom rigs are key factors in fishing efficiency, bait presentation, and reducing tangles and snags. Bottom rigs are essential for catching fish that dwell near the bottom of a body of water such as lakes, rivers, or oceans. Increasing the ease of attaching the bottom rig to the fishing rod and it would be advantageous to have a bottom rig that attached directly to the swivel.

### SUMMARY

In one exemplary embodiment, the present disclosure provides a bottom rig including: (a) a metal tube; (b) a casting material within the metal tube; (c) a wire loop running through and extending beyond the casting material and the metal tube; (d) a top slide ring removably attached to a top of the wire loop; and (e) a bottom slide ring removably attached to a bottom of the wire loop; wherein the top slide ring is removably attachable to a swivel on a fishing rod.

In one exemplary embodiment, the present disclosure provides a bottom rig including: (a) a metal tube; (b) a lead casting material within the metal tube; (c) a wire loop running through and extending beyond the lead casting material and the metal tube; (d) a top slide ring removably attached to a top of the wire loop; and (e) a bottom slide ring removably attached to a bottom of the wire loop; wherein the top slide ring is removably attachable to a swivel on a fishing rod; wherein the metal tube, wire loop, top slide ring and bottom slide ring comprise stainless stee; and wherein the bottom rig has a weight ranging from 0.5 ounces to 2.5 ounces.

In another embodiment, the techniques described herein relate to a process for making a bottom rig, the process including: (a) obtaining a metal tube, a lead object, a wire, a top slide ring, and a bottom slide ring; (b) shaping the wire into a wire loop; (c) inserting the wire loop into the metal tube to form a step (c) product; (d) placing the step (c) product on a holder; (e) heating the lead object to make a liquified lead; (f) pouring a portion of the liquified lead into the step (c) product and allowing the portion of the liquified lead to cool into a casting material to form a step (f) product; and (g) attaching the top slide ring to the wire loop at a top side of the step (f) product and attaching the bottom slide ring to the wire loop at a bottom side of the step (f) product, wherein the wire loop extends beyond a top and a bottom of the metal tube, wherein the bottom of the metal tube is flush with the holder and a bottom of the wire loop hangs below a slit in the holder when the step (c) product is placed on the holder, wherein the portion of the liquified lead is substantially contained within the metal tube, and wherein the step (f) product is removable from the holder.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic of a perspective view of a non-limiting embodiment of the inventive bottom rig;

FIG. 2a is a schematic of a side view of the bottom rig shown in FIG. 1, without the slide rings and hook;

FIG. 2b is a schematic of cross sectional view AA taken along the plane of the wire loop in the tube of the bottom rig of FIG. 1;

FIG. 2c is a schematic of a bottom view of the bottom rig shown in FIG. 2a.

### DETAILED DESCRIPTION

According to an embodiment the present disclosure provides a bottom rig including: (a) a metal tube; (b) a casting material within the metal tube; (c) a wire loop running through and extending beyond the casting material and the metal tube; (d) a top slide ring removably attached to a top of the wire loop; and (e) a bottom slide ring removably attached to a bottom of the wire loop. The top slide ring is removably attachable to a swivel on a fishing rod.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is to be understood that the mention of one or more method steps does not preclude the presence of additional method steps before or after the combined recited steps or intervening method steps between those steps expressly identified. Moreover, the lettering of method steps or ingredients is a conventional means for identifying discrete activities or ingredients and the recited lettering can be arranged in any sequence, unless otherwise indicated.

As used herein, the term “and/or”, when used in a list of two or more items, means that any one of the listed items can be employed by itself, or any combination of two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the terms “slide ring” and “slide-on ring” are used interchangeably and refer to a type of ring design allowing it to slide or move along a tube of another component. A common example is a key ring that has a sliding mechanism that allows for easy attachment and detachment of keys.

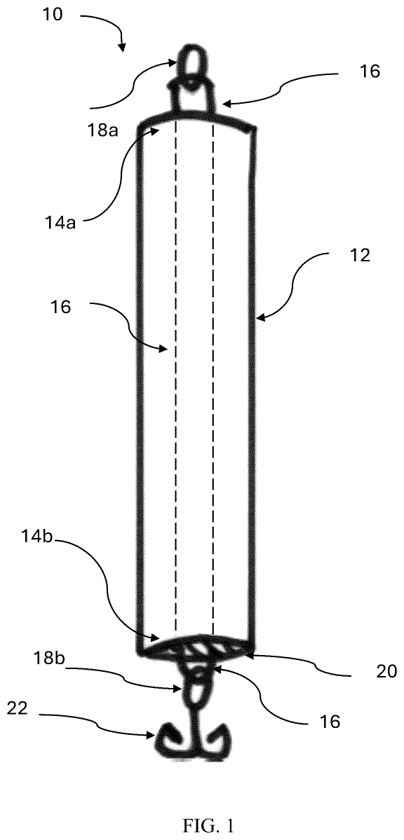

FIG. 1 is a schematic of a perspective view of a non-limiting embodiment of the inventive bottom rig 10. The bottom rig 10 has a metal tube 12. The metal tube 12 has a top end 14a and a bottom end 14b. A wire loop 16 extends from within the tube 12 past both the top end 14a and the end bottom 14b of the metal tube 12. A top slide ring 18a is removably attached to wire loop 16 proximal to the top end 14a and a bottom slide ring 18b is removably attached to wire loop 16 proximal to the bottom end 14b of the metal tube 12. The wire loop 16 is held within the metal tube 12 via a casting material 20. The casting material 20 fills of the metal tube 12. Also connected to the bottom slide ring 18b is a treble hook 22. The top slide ring 18a can be removably attached to a swivel (not shown) on a fishing rod (not shown). FIG. 1 is a schematic of the bottom rig 10 as it looks hanging from a fishing rod (not shown).

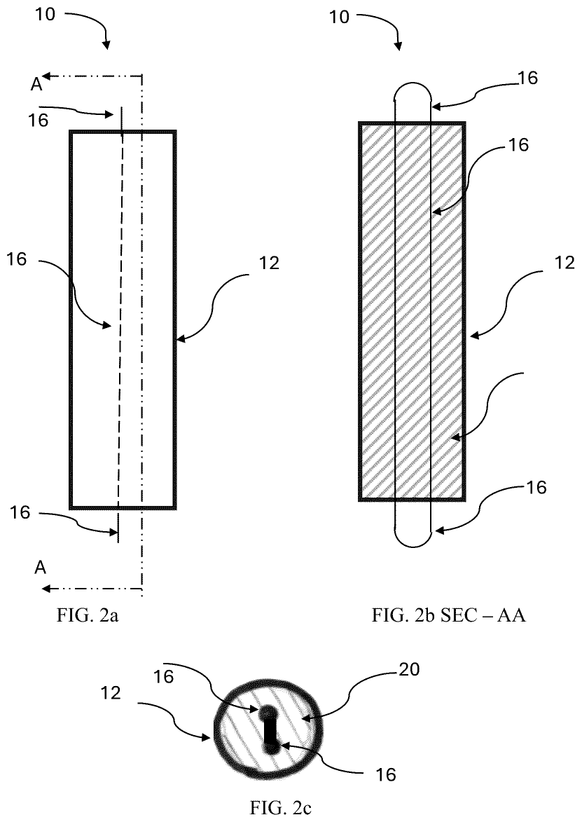

FIG. 2a is a schematic of a side view of the bottom rig 10 shown in FIG. 1, without the slide rings and the hook shown. FIG. 2b is a schematic of cross sectional view AA taken along the plane of the wire loop 16 through the metal tube 12 as oriented in FIG. 2a. FIG. 2c is a schematic of a bottom view of the bottom rig 10 shown as oriented in FIG. 2a.

The bottom rig comprises: (a) a metal tube; (b) a casting material within the metal tube; (c) a wire loop running through and extending beyond the casting material and the metal tube; (d) a top slide ring removably attached to a top of the wire loop; and (e) a bottom slide ring removably attached to a bottom of the wire loop. The top slide ring is removably attachable to a swivel on a fishing rod. In some aspects, the bottom rig further comprises: (f) a hook removably attachable to the bottom slide ring.

The materials of construction for the different parts of the bottom rig are not particular limited as long as they are strong enough to withstand the bite and weight of the fish to be caught. In some aspects, the bottom rig comprises shiny material to help attract fish. In some aspects, the metal tube, the wire loop, the top slide ring, and/or the bottom slide ring comprise stainless steel, brass, and/or tungsten. In some aspects, a material of the metal tube, the wire loop, the top slide ring, and/or the bottom slide ring is selected from the group consisting of stainless steel, brass, or tungsten. In some aspects, the metal tube, the wire loop, the top slide ring, and the bottom slide ring comprise stainless steel.

The casting material of the bottom rig is used to hold the wire loop in place and contribute to the overall weight of the bottom rig. In some aspects, the casting material comprises lead, stainless steel, bronze and/or tungsten. In some aspects, the casting material comprises lead. In some aspects, the casting material consists essentially of lead.

The bottom rig is designed to be built in a variety of weights as different weights are used for different fishing objectives. In some aspects, the bottom rig, without a hook attached, ranges from 0.5 ounces to 2.5 ounces. In some aspects, the weight of the bottom rig, without the hook attached, is selected from the group consisting of 0.5 ounces, 1.0 ounce, 1.5 ounces, 2.0 ounces, and 2.5 ounces. In some aspects, the bottom rig is completely submerged, the top slide ring is underwater, when the bottom rig is cast into the water at each of the weights ranging from 0.5 ounces to 2.5 ounces.

The gauge of the wire used to make the wire loop is not particularly limited as long as it is strong enough to remain intact when fishing and produces a wire loop small enough to fit within the metal tube, with sufficient room for the casting material. In some aspects, a gauge of the wire loop is selected from the group consisting of 18, 20, 22, or 24. In some aspects, the wire loop is formed by steps comprising: (a) obtaining a wire and cutting it to a desired length; (b) forming the wire loop, wherein a first end and a second end of the wire overlap; and (c) twisting and/or welding the first end and the second end together. In some aspects, the wire overlap is positioned in the bottom half of the metal tube.

In some aspects, a diameter for each of the top slide ring and the bottom slide ring is independently selected from the group consisting or 8 mm, 10 mm, or 12 mm.

The varied weights of the bottom rig depend upon the materials used and the sizes of the metal tube, wire loop, and slide rings. The dimensions of the metal tube set the volume of the casting material. In some aspects and outside diameter of the metal tube ranges from ¼ inches to ½ inches, and a length of the metal tube ranges from 1.5 inches to 4 inches. Non-limiting prototypes of the bottom rig were made with stainless steel tubing, stainless steel wire, stainless steel slide rings, and lead as the casting material. All stainless steel tubing was 1 mm thick. Table 1 shows the dimensions for each weight of the bottom rig.

TABLE 1
Dimensions of non-limiting prototype bottom rigs

| Weight of | Stainless Steel Tubing | | | Slide ring |
|---|---|---|---|---|
| bottom rig w/o | Outside diameter | Length | Wire | diameter |
| hook (ounces) | (inches) | (inches) | gauge | (mm) |
| 0.5 | ¼ | 2 | 18 | 10 |
| 1 | 5/16 | 2 | 18 | 10 |
| 1.5 | ¼ | 4 | 18 | 10 |
| 2 | 5/16 | 3.5 | 18 | 10 |
| 2.5 | 5/16 | 4 | 18 | 10 |

The hook can be made of the same material as the other parts of the bottom rig or of a different material. In some aspects, the hook comprises gold, bronze, brass, tungsten, and/or stainless steel. In some aspects the hook comprises gold, bronze, and/or stainless steel. In some aspects, the hook is selected from the group consisting of gold, bronze, or stainless steel. In some aspects, the weight of the hook is selected from the group consisting of 0.5 ounces, 1 ounce, 1.5 ounces, 2 ounces, or 2.5 ounces.

In another embodiment, the techniques described herein relate to a process for making a bottom rig, the process comprising: (a) obtaining a metal tube, a lead object, a wire, a top slide ring, and a bottom slide ring; (b) shaping the wire into a wire loop; (c) inserting the wire loop into the metal tube to form a step (c) product; (d) placing the step (c) product on a holder; (e) heating the lead object to make a liquified lead; (f) pouring a portion of the liquified lead into the step (c) product and allowing the liquified lead to cool into a casting material to form a step (f) product; and (g) attaching the top slide ring to the wire loop at a top side of the step (f) product and attaching the bottom slide ring to the wire loop at a bottom side of the step (f) product, wherein the wire loop extends beyond a top and a bottom of the metal tube, wherein the bottom of the metal tube is flush with the holder and a bottom of the wire loop hangs below a slit in the holder when the step (c) product is placed on the holder, wherein the portion of the liquified lead is substantially contained within the metal tube, and wherein the step (f) product is removable from the holder.

In some aspects, the process of making a bottom rig further comprises: (h) obtaining a hook and attaching the hook to the bottom slide ring.

In some aspects, the bottom rig comprises shiny material to help attract fish. In some aspects, the metal tube, the wire loop, the top slide ring, and/or the bottom slide ring comprise stainless steel, brass, and/or tungsten. In some aspects, the metal tube, the wire loop, the top slide ring, and/or the bottom slide ring are selected from the group consisting of stainless steel, brass, or tungsten. In some aspects, the metal tube, the wire loop, the top slide ring, and the bottom slide ring comprise stainless steel.

In some aspects, the bottom rig, without a hook attached, ranges from 0.5 ounces to 2.5 ounces. In some aspects, the weight of the bottom rig, without the hook attached, is selected from the group consisting of 0.5 ounces, 1.0 ounce, 1.5 ounces, 2.0 ounces, and 2.5 ounces. In some aspects, the bottom rig is completely submerged, the top wire slide ring is underwater, when the bottom rig is cast into the water at all weights ranging from 0.5 ounces to 2.5 ounces.

In some aspects and outside diameter of the metal tube ranges from ¼ inches to ½ inches, and a length of the metal tube ranges from 1.5 inches to 4 inches.

In some aspects, a gauge of the wire is selected from the group consisting of 18, 20, 22, or 24. In some aspects, the shaping of the wire loop, step (b) comprises (i) cutting the wire to a desired length; (ii) forming the wire loop, wherein a first end and a second end of the wire overlap; and (iii) twisting and/or welding the first end and the second end together.

In some aspects, a diameter for each of the top slide ring and the bottom slide ring is independently selected from 8 mm, 10 mm, or 12 mm.

The hook can be made of the same material as the other parts of the bottom rig or of a different material. In some aspects, the hook comprises gold, bronze, brass, tungsten, and/or stainless steel. In some aspects the hook comprises gold, bronze, and/or stainless steel. In some aspects, the hook is selected from the group consisting of gold, bronze of stainless steel. In some aspects, the weight of the hook is selected from the group consisting of 0.5 ounces, 1 ounce, 1.5 ounces, 2 ounces, or 2.5 ounces.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A bottom rig comprising:
a) a metal tube;
b) a casting material within the metal tube;
c) a wire loop running through and extending beyond the casting material and the metal tube;
d) a top slide ring removably attached to a top of the wire loop; and
e) a bottom slide ring removably attached to a bottom of the wire loop;
wherein the top slide ring is removably attachable to a swivel on a fishing rod.

2. The bottom rig of claim 1, further comprising:
f) a hook removably attachable to the bottom slide ring.

3. The bottom rig of claim 1, wherein the metal tube, the wire loop, the top slide ring, and/or the bottom slide ring comprise stainless steel, brass, and/or tungsten.

4. The bottom rig of claim 1, wherein the casting material comprises lead.

5. The bottom rig of claim 1, wherein a weight of the bottom rig, without a hook attached, ranges from 0.5 ounces to 2.5 ounces.

6. The bottom rig of claim 1, wherein an outside diameter of the metal tube ranges from ¼ inches to ½ inches, and a length of the metal tube ranges from 1.5 inches to 4 inches.

7. The bottom rig of claim 1, wherein a gauge of the wire loop is selected from the group consisting of 18, 20, 22, or 24.

8. The bottom rig of claim 7, wherein the wire loop if formed by steps comprising:
i) cutting a wire to a desired length;
ii) forming the wire loop, wherein a first end and a second end of the wire overlap; and
iii) twisting and/or welding the first end and the second end together.

9. The bottom rig of claim 1, wherein a diameter for each of the top slide ring and the bottom slide ring is independently selected from the group consisting of 8 mm, 10 mm, or 12 mm.

10. The bottom rig of claim 2, wherein the hook comprises gold, bronze, brass, tungsten, and/or stainless steel.

11. The bottom rig of claim 2, wherein a weight of the hook is selected from the group consisting of 0.5 ounces, 1 ounce, 1.5 ounces, 2 ounces, or 2.5 ounces.

12. A process for making a bottom rig, the process comprising:
a) obtaining a metal tube, a lead object, a wire, a top slide ring, and a bottom slide ring;
b) shaping the wire into a wire loop;
c) inserting the wire loop into the metal tube to form a step (c) product;
d) placing the step (c) product on a holder;
e) heating the lead object to make a liquified lead;
f) pouring a portion of the liquified lead into the step (c) product and allowing the portion of the liquified lead to cool into a casting material to form a step (f) product; and
g) attaching the top slide ring to the wire loop at a top side of the step (f) product and attaching the bottom slide ring to the wire loop at a bottom side of the step (f) product,
wherein the wire loop extends beyond a top and a bottom of the metal tube,
wherein the bottom of the metal tube is flush with the holder and a bottom of the wire loop hangs below a slit in the holder when the step (c) product is placed on the holder,
wherein the portion of the liquified lead is substantially contained within the metal tube, and
wherein the step (f) product is removable from the holder.

13. The process of claim 12 further comprising:
h) obtaining a hook and attaching the hook to the bottom slide ring.

14. The process of claim 12, wherein the metal tube, the wire loop, the top slide ring, and/or the bottom slide ring comprise stainless steel, brass, tungsten.

15. The process of claim 12, wherein a weight of the bottom rig, without a hook attached, ranges from 0.5 ounces to 2.5 ounces.

16. The process of claim 12, wherein an outside diameter of the metal tube ranges from ¼ inches to ½ inches, and a length of the metal tube ranges from 1.5 inches to 4 inches.

17. The process of claim 12, wherein a gauge of the wire is selected from the group consisting of 18, 20, 22, or 24.

18. The process of claim 17, wherein the shaping of the wire loop comprises:
i) cutting the wire to a desired length;
ii) forming the wire loop, wherein a first end and a second end of the wire overlap; and
iii) twisting and/or welding the first end and the second end together.

19. The process of claim 12, wherein a diameter for each of the top slide ring and the bottom slide ring is independently selected from 8 mm, 10 mm, or 12 mm.

20. The process of claim 13, wherein the hook comprises gold, bronze, and/or stainless steel, and
wherein, a weight of the hook is selected from the group consisting of 0.5 ounces, 1 ounce, 1.5 ounces, 2 ounces, or 2.5 ounces.
